(19) United States
(12) Patent Application Publication
(10) Pub. No.: US 2016/0159142 A1
(43) Pub. Date: Jun. 9, 2016

(54) MODULAR WHEEL CENTER CAP SYSTEM

(71) Applicant: Wheel Pros, LLC, Greenwood Village, CO (US)

(72) Inventor: Jeffery Whitten, Parker, CO (US)

(73) Assignee: WHEEL PROS, LLC, Greenwood Village, CO (US)

(21) Appl. No.: 14/562,688

(22) Filed: Dec. 6, 2014

(51) Int. Cl. B60B 7/00

(52) U.S. Cl. CPC B60B 7/0013; B60B 2900/211; B60B 2900/541

(57) ABSTRACT

A modular wheel center cap system for a vehicle wheel, comprising interchangeable components to readily modify the functional and aesthetic aspects of the wheel and provide access to the wheel hub assembly.

### RELATION TO OTHER PATENTS

This is an originally file non-provisional application

### BACKGROUND

1. Field

The present disclosure relates generally to vehicle wheels and more particularly to wheel center cap systems and methods for attachment of a wheel center cap.

2. Related Art

Wheel caps of various configurations are known. Wheel caps may be used to cover the center hole of a wheel hub assembly to prevent the entry of dirt and moisture. Wheel caps have also been used for ornamental or decorative purposes to modify the design, style or finished look of a wheel. Some wheel center caps may display a desired design, logo, or emblem. Other wheel center caps may be used to hide lug nuts that are used to secure a wheel to a motor vehicle. End user may desire to easily modify or change the appearance of a wheel without replacement of the entire wheel, which is expensive and wasteful.

In four wheel drive vehicles, the driver may need easy access to a vehicle wheel hub to readily engage the center deferential and change between two wheel drive to four wheel drive. With a wheel center cap covering the central hub, access to the hub may be inhibited, preventing easy access. Elimination of the center cap makes for ready access to the hub, but also eliminates desirable aesthetics aspects. Therefore a need exists for a low cost wheel center cap system that provides for flexibility and interchangeability in the aesthetics of the wheel and also provides for ready access to a center wheel hub.

Therefore a need exists for a solution to the aforementioned problem of providing The present teachings provide such a system.

### SUMMARY

In view of the foregoing background, it is therefore an object of the invention to provide a modular wheel center cap system. The modular vehicle wheel center cap system provides for the interchangeability of various system components to easily modify the aesthetics of the wheel, while providing easy access to functional aspect of the wheel hub assembly.

It one aspect of the invention, provided is a modular vehicle wheel center caps system that provides for easy access to the center hub of a wheel assembly, while maintaining aesthetic appeal of center cap. Easy access provides for quick and ready maintenance and cleaning of the wheel hub assembly.

In another aspect of the invention, a wheel center cap system is provided that allows for easy replacement of system components in the event of damage to a single component. Thus, only replacing those parts that are damaged is necessary, saving cost and reducing waist.

In yet another aspect of the invention, provided is a wheel center cap system that provides for interchangeability of system components to provide easy change of the aesthetic appearance of the wheel.

In another aspect of the invention, a wheel center cap system is provided that allow for changing the wheel hub configuration for easy reconfiguration of the four wheel drive differential without loss of desirable aesthetics.

In another aspect of the invention, a wheel center cap system is provided for vehicle compatibility options, including compatibility to modified vehicle wheels, such as for 4×4 vehicles using manual locking front hubs, trailers with special hubs.

Other advantages of this invention will become apparent to those skilled in the art from the following detailed description of the invention, when read in light of the accompanying drawings. Further areas of applicability of the present teachings will become apparent from the detailed description provided. It should be understood that the detailed description and specific examples are intended for purposes of illustration only and are not intended to limit the scope of the present teachings.

### BRIEF DESCRIPTION OF THE DRAWINGS

Embodiments of the present disclosure will be more readily understood by reference to the following figures, in which like reference numbers and designations indicate like elements.

FIG. 1 is an exploded profile view illustrating one embodiment of a wheel center cap system according to the present teachings.

FIG. 2A is an illustration of an assembled wheel center cap system according to the present invention.

FIG. 2B is an illustration of a disassembled wheel center cap system according to the present invention.

FIG. 3 is a representation of the decorative end cap piece showing one embodiment of the attachment mechanism of the present teachings.

FIG. 4 is an illustration showing a plurality of decorative end cap embodiments of the wheel center cap system according aspects of the present teachings.

FIG. 5A and 5B are representations of one embodiment of the aspects of the wheel center cap system showing access to a wheel hub assembly.

### DETAILED DESCRIPTION OF THE PREFERRED EMBODIMENTS

The present invention will now be described more fully with reference to the accompanying drawings. This invention may be embodied in many different forms and should not be construed as limited to the illustrated embodiments disclosed. Rather, these embodiments are provided so that this disclosure will be thorough and complete, and will fully convey the scope of the invention to those skilled in the art. Like numbers refer to like elements throughout. The modular wheel center cap system will now be described in detail.

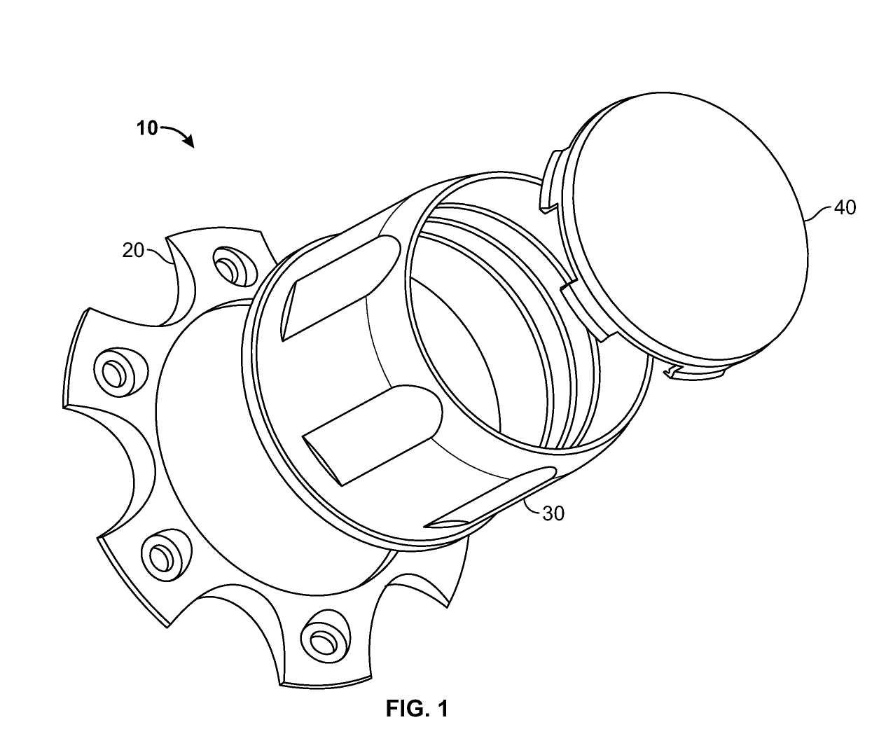

Referring now to the drawings. FIG. 1 provides an exploded profile view of one embodiment of a modular wheel center cap system 10. The system 10 is comprised of an annular mounting plate 20, a drum member 30 and a decorative end cap member 40. Each of the system components may be formed in any of a plurality of shapes and decorative configurations that provide for a unique aesthetic appearance of the system as a whole when installed on a vehicle wheel. The system components may be constructed from any suitable material, such as metal, hard plastic or ceramic.

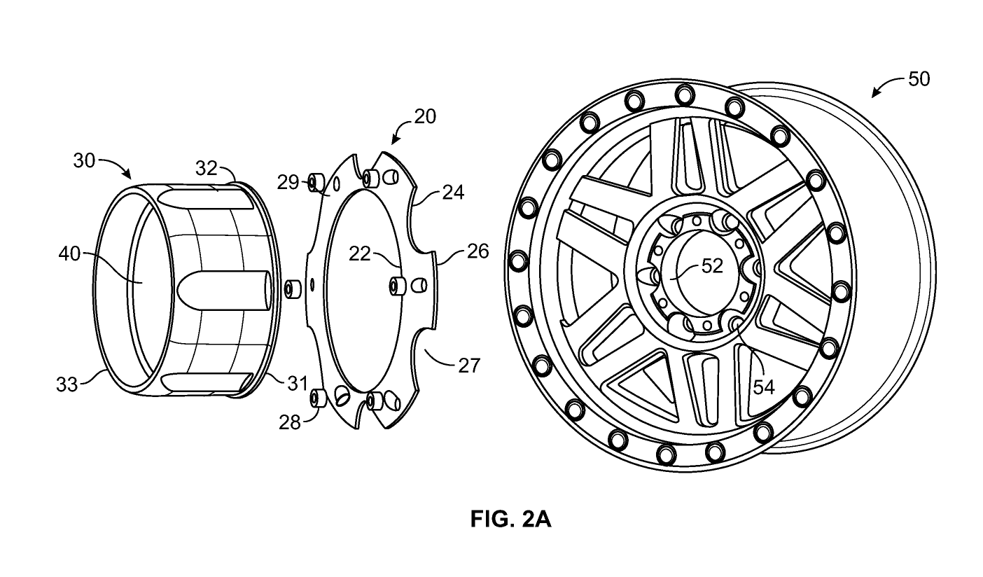

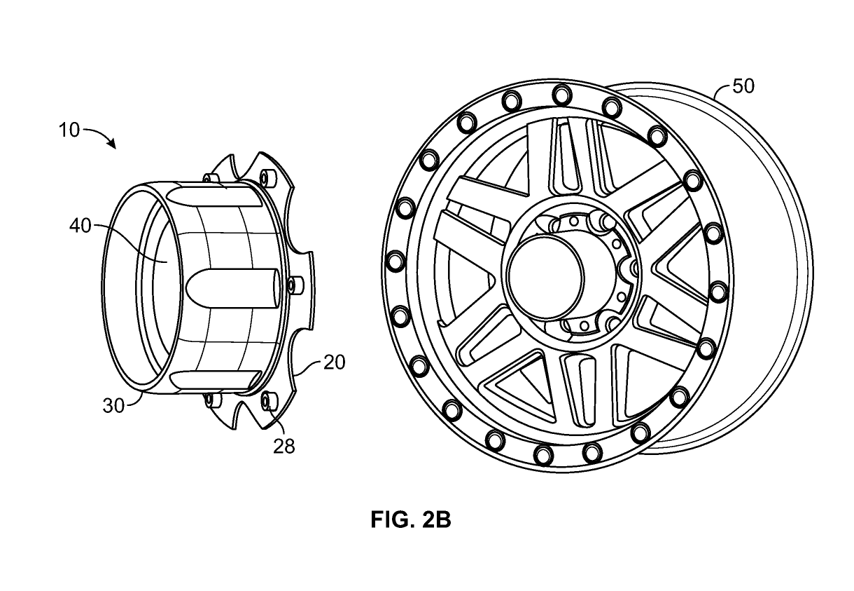

FIG. 2 shows the mounting plate 20 having a interior portion 22 and an exterior portion 24. The interior portion 22 in on embodiment is annular with a diameter that matches the central portion 52 of the wheel 20 on which the system is installed. However, the mounting plate 20 may take any desirable shape to match the functional or aesthetics of the wheel 50. The exterior portion 24 may have a plurality of axially extending projections 26 disposed around a circumference thereof. The projections 26 are configured to provide a plurality of recess areas 27 whereby the mounting plate can be attached to the wheel 50 without interfering with the wheel lug holes 54. The mounting plate 20 will include along the circumference of the interior portion 22 a flanged ridge (not shown). The mounting plate 20 is preferably secured to the wheel 50 using a plurality of cylinder screws 28 threaded through a plurality of mounting holes 29.

The system is further comprised of a drum member 30 having a proximal end 32 and a distal end 33, with a height X that can be any desirable heights between the proximal end 32 and distal end 33. The drum member 30 in the shown embodiment is cylindrical, but can be any desirable shape. The drum member 30 has a flange 32 around the circumference of the drum member 30 on the proximal end 31. The diameter of the drum member 30 is only slightly smaller than the diameter of the mounting plate 20, such that the mounting plate 20 can slide over the drum member 30.

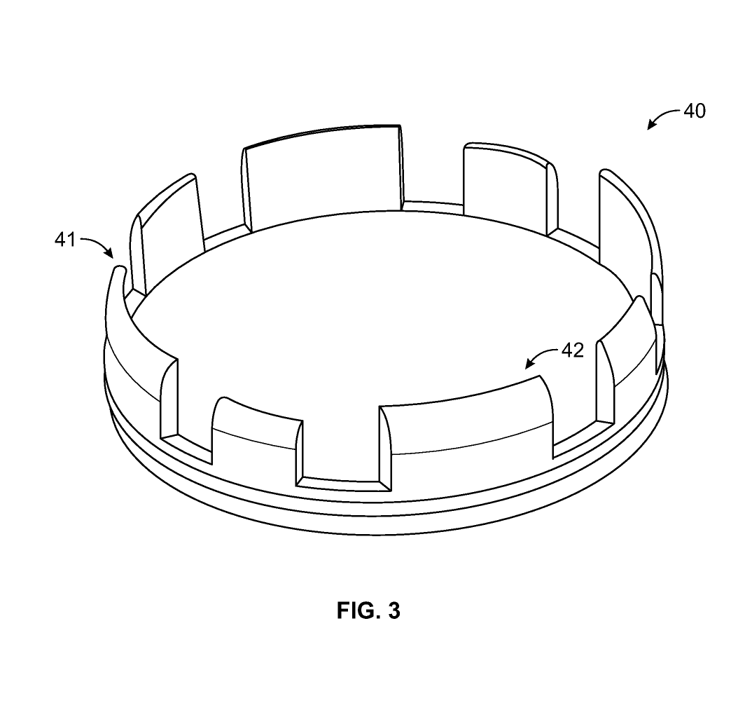

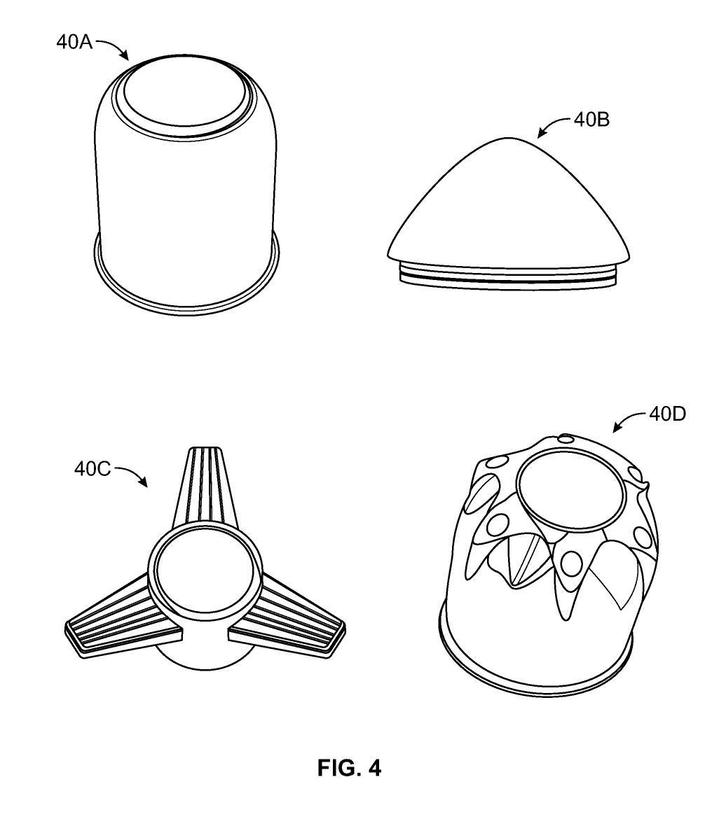

Now with reference to FIGS. 2, 3, and 4. The system 10 further includes a decorative end cap 40. FIG. 2A and 2B shows the end cap 40 already secured in the drum member 40. Referring to FIG. 3., the end cap 40 is secured to the drum member 30 with a plurality of extended tongs 41 with a angled broad ends 41 that allow for mechanical fastening. It will be appreciated by one skilled in the art that the joining of the end cap 40 to the drum member 30 may be through any mechanical fastener such as bolts, rivets, threading, clips, tongue and groove, slot and tab, etc. FIG. 4 shows a plurality of end cap designs 40A, 40B, 40C and 40C. Many decorative end cap designs are envisioned with the current invention. Each end cap 40 is decorative, interchangeable and provides for a variety of aesthetic appearances for the wheel 50 when used with the disclosed system. Interchangeability allows for easy replacement of the system components if damaged by a road hazard or if it is desired to have a new look for the wheel. Interchangeability also provides for an inexpensive means to improve the appearance of the wheel without replacement of the entire wheel.

Now referring again to FIG. 2, after selecting the desired decorative end cap 40 and interchangeable drum member 30, the system 10 is secured to the wheel 50 using the mounting plate 20. In the disclosed embodiment, the mounting plate 20 slides over the drum member 30 and the flanged edge of the mounting plate (not shown) is seated with the flanged edge of the drum member 31. When the mounting plate 20 is secured to the wheel 50 using the cylinder screws 28, the drum member 30 is held in place by the compression of the mounting plate 20, as is show in FIG. 2B. Other means for securing the drum member 31 and mounting plate 20 are contemplated, include tongue and groove, tab in slot, threading or any other know attachment means.

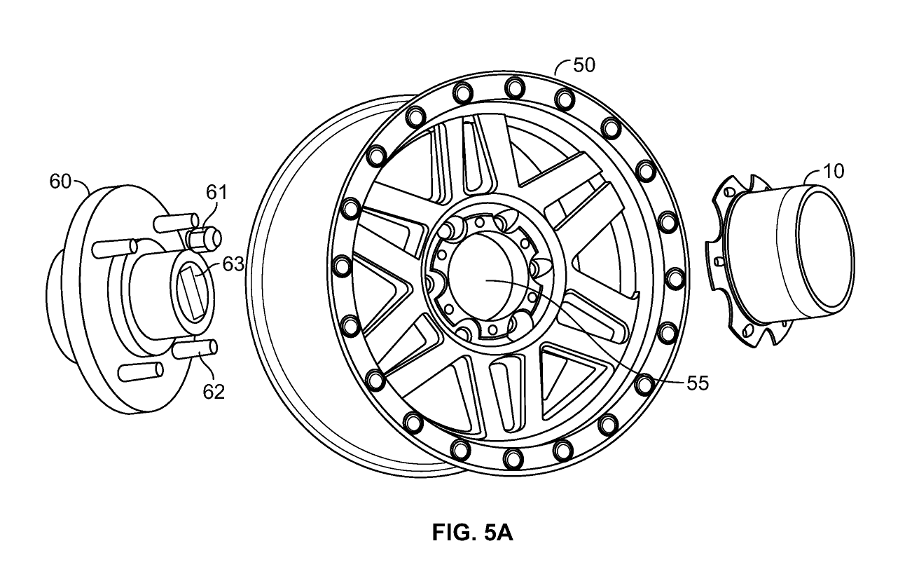

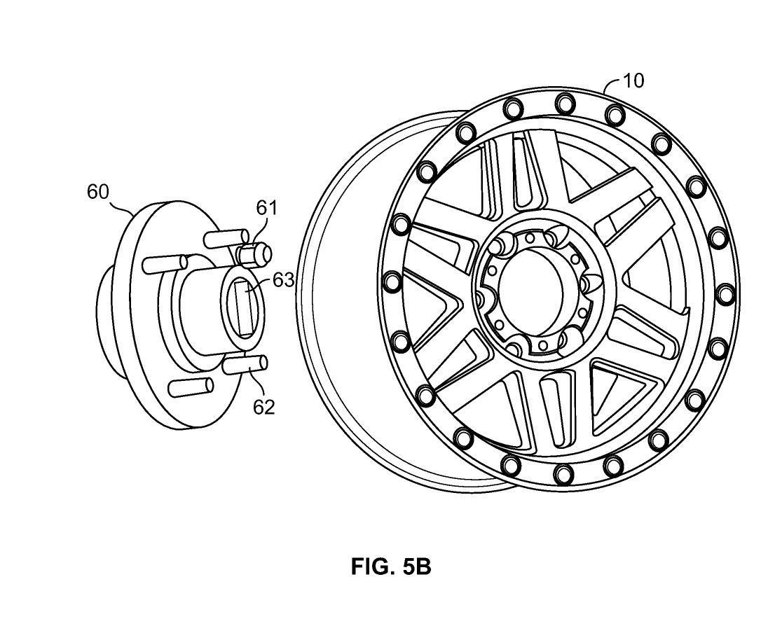

Now with reference to FIGS. 5A and 5B, shown is a vehicle wheel hub assembly 60 without the vehicle wheel 50 attached. The wheel 50 is secured to the wheel hub assembly 60 using standard lug nuts 61 threaded to the lug bolts 62. As shown, the wheel hub assembly is for a four wheel drive vehicle and includes a center dial 63 to lock in the four wheel drive differential. The center dial 63 is rotated in one direction to engage or lock in the differential and rotated in the other direction to disengage or unlock the differential. Generally, the center dial 63 must be accessible to the driver for this purpose. This requires that any wheel installed must leave open an area 55 at the center of the wheel 50 whereby the center dial 63 can be accessed. However, having the center dial 63 expose, the decorative aspects of the wheel 50 are limited, and the wheel hub assembly 60 is exposed to dirt and moisture that can accelerate wear. The current invention eliminates these issues by creating a modular wheel center cap system 10 that allows access to the wheel hub assembly 60 while providing a configuration for accommodating decorative elements. FIG. 5B shows the assembled wheel center cap system 10 secured to the wheel 50. The system drum member can be selectively removed and reinstalled to allow access to the center dial 63 when removed and prevent dirt and moisture when installed. Installation can be through a tab and groove arrangement. When tabs from the drum member are inserted into the grooves in the mounting plate and rotated in a locking position, the drum member becomes securely attached. Further, when rotated in the opposite direction the drum member becomes un-attached, allowing access to the center dial 63.

The foregoing description illustrates exemplary implementations, and novel features, of aspects of an modular vehicle wheel center caps system. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art.

What is claimed is:

1. A modular wheel center cap system for installation on a vehicle wheel having a wheel hub assembly and a plurality of lug holes, the system comprising:
a mounting plate having a substantially flat top side and bottom side, an interior annular void portion, an exterior edge portion, the mounting plate comprising at least one attachment means for securing the system to the wheel;
a drum member having a proximal end and a distal end, the drum member having a diameter smaller than the annular void such that the mounting plate can be fitted over the drum member;
a cap member removably secured to the drum member distal end.

2. The modular wheel center cap system of claim 1 wherein the mounting plate interior annular portion has a diameter sufficient to provide access to the hub assembly of the wheel on which the system is mounted, and the mounting plate exterior portion has a configuration selected from a plurality of decorative configurations.

3. The modular wheel center cap system of claim 1 wherein the exterior portion of the mounting plate is further comprised by a plurality of axially extending projections disposed around a circumference thereof, the projections are configured to provide a plurality of recess areas whereby the mounting plate can be attached to the wheel without limiting access to the wheel lug holes.

4. The modular wheel center cap system of claim 1 wherein the drum member is further comprised of a flange surrounding the circumference at the proximal end, the drum member secured to the wheel by a compression force on the flange generated by contact with the mounting plate when the mounting plate is fitted over the drum member and the at least one securing means secures the mounting plate to the wheel.

5. The modular wheel center cap system of claim 1 wherein the mounting plate is selected from a plurality of mounting plates each having a different decorative appearance.

6. The modular wheel center cap system of claim 1 wherein the cap member is selected from a plurality of caps each having a different decorative appearance.

7. The modular wheel center cap system of claim 1 wherein the drum member is selected from a plurality of drum members each having a different decorative appearance.

8. The modular wheel center cap system of claim 1 wherein the proximal end of the drum member has a diameter that is substantially the same as the diameter of the wheel hub of the wheel on which it is mounted and access to the wheel hub is provided when the cap member is removed.

9. The modular wheel center cap system of claim 1 wherein the cap member has a diameter at least as large as the wheel hub on which the system is mounted and access to the wheel hub is provided when the cap member is removed from the drum member.

10. The modular wheel center cap system of claim 1 wherein the cap member has a diameter at least as large as the wheel hub on which the system is mounted and access to the hub is provided when the cap member is removed from the drum member such that the wheel hub configuration can be changed from two wheel drive to four wheel drive.
